(19) United States
(12) Patent Application Publication
(10) Pub. No.: US 2008/0266114 A1
(43) Pub. Date: Oct. 30, 2008

(54) ELECTRIFIED CONTAINER FOR ANIMAL DETERRENCE

(76) Inventors: Josh Leavitt, Newton, UT (US); Brian Frankle, Logan, UT (US)

Correspondence Address: DYKAS, SHAVER & NIPPER, LLP, P.O. BOX 877, BOISE, ID, 83701-0877, US

(21) Appl. No.: 12/110,788

(22) Filed: Apr. 28, 2008

Related U.S. Application Data
(60) Provisional application No. 60/914,241, filed on Apr. 26, 2007.

(51) Int. Cl. A01K 15/04; G08B 23/00

(52) U.S. Cl. 340/573.2; 119/57.9

(57) ABSTRACT

An electrified container for deterring an animal from accessing the contents thereof. The storage container having at least one access aperture and at least one section of electrically conductive material attached to the exterior of said storage container. Preferably, the section of electrically conductive material is configured to conduct current through an animal upon contact with the container, thus providing an electric shock to the animal.

### CROSS-REFERENCE TO RELATED APPLICATIONS

This application claims the priority date of the provisional application entitled Electrified Container for Animal Deterrence, filed by Leavitt et al. on Apr. 26, 2007 with application Ser. No. 60/914,241, the disclosure of which is hereby incorporated by reference.

### FIELD OF THE INVENTION

The preferred embodiment of the present invention generally relates to containers for storing goods, and more particularly relates to electrified, animal resistant containers for deterring animal entry into the container.

### BACKGROUND OF THE INVENTION

In the wilderness, it is not uncommon for individuals such as campers, hikers and hunters (hereinafter “campers”) to, while they are there, set up temporary living quarters. These temporary living quarters are often referred to as a “camp.”

These campers, in order to survive, logically bring food items with them to the camp. A problem arises when wild animals, for instance, bears, can smell these human food items and are drawn into the humans' camp in search of food. Many bear attacks have been caused by campers carelessly cooking and/or storing food at their campsite. To prevent such attacks, campers are frequently reminded of the necessity of not storing food (for example, raw food, leftovers, snacks, and dirty dishes) in their campsites.

One common tool used to “bear proof” a campsite is a “bear bag,” whereby the camp's food is placed in a bag and the bag is hoisted up into a tree, well out of the reach of a bear. Examples of such inventions include the “lightweight bear bag” of Cohen (U.S. Pat. No. 6,332,713) and the “bear bag system” of Judy (U.S. Pat. No. 5,950,981). While the animal may not get your food, the food is rendered into the unsatisfactory state of being crushed. In addition, none of these devices does anything to actively discourage repeated attempts at entry.

Other patents show animal proof containers, e.g., DeForrest et al. (U.S. Pat. No. 6,343,709) and McCall et al. (U.S. Pat. No. 4,801,039). Such animal proof containers are often made of hard materials (such as aluminum, carbon fiber, plastic, composites, and/or textiles) that are difficult for the animal to chew through. These animal proof containers typically focus on creating a container that does not allow any animal entry (after chewing on the container for a while, the animal eventually gives up). These containers do nothing to prevent further attempts at access and still put the contents in danger of being damaged as the animal attempts to gain access.

The prior art also contains a number of different inventions designed for keeping animals from rummaging through garbage cans (Rogers—U.S. Pat. No. 4,274,123; Boyd—U.S. Pat. No. 3,480,176; and Roestenberg et al.—U.S. Pat. No. 5,864,292); as well as devices for preventing animals (typically squirrels) from stealing bird feed from a bird feeder (Doubleday et al.—U.S. Pat. No. 2,856,898; and Caldine—U.S. Pat. No. 5,285,747).

### SUMMARY OF THE INVENTION

In order to maintain various food items and other personal belongings in the wilderness, one must maintain these items in an area or package that is logistically difficult for animals to access. In order to insure not only that a wild animal cannot attain access to an individual's belongings, but also receive negative feedback from the experience, an electrified container for animal deterrence is presented. When an animal attempts to gain access to the electrified container, the animal will come into contact with electrically conductive sections on the outside of the container. These electrically conductive sections are controlled by an attached voltage regulator. Upon contact with the electrically conductive sections, the animal will receive an electric shock and will abandon attempt to gain entry to the container. Further, with repeated negative reinforcement, it is intended that the animal will no longer attempt to gain entry to containers of the same type, in fear of electric shock.

In one embodiment, an electrified container for animal deterrence is provided, this container comprising a storage container, at least one section of electrically conductive material, a voltage controller, and a power source. The storage container being configured so as to form an interior space. The interior space being accessible through at least one access aperture through a sidewall or endwall of the container. The section of electrically conductive material is preferably fixedly attached to the exterior of the storage container and is configured to conduct current through the animal (a grounded object) when the animal comes into contact with the electrically conductive material. The voltage controller is electrically attached to the section of electrically conductive material and is configured to control the electrification of the section of said electrically conductive material. The power source is electrically interfaced with the voltage controller and is configured to provide electrical energy to the voltage controller. In use, this embodiment of electrified container is thusly configured to provide an electric shock to any animal that comes into contact with the section of electrically conductive material, for instance if the animal was attempting to access the contents (e.g., food) of the container.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 shows a perspective view of a first embodiment of the present invention.

FIG. 2 shows a second perspective view of the embodiment of FIG. 1.

FIG. 3 shows a first end view of the embodiment of FIG. 1.

FIG. 4 shows a second end view of the embodiment of FIG. 1.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “or” indicates a non-exclusive alternative without limitation unless otherwise noted. The use of “including” means “including, but not limited to,” unless otherwise noted.

The present invention is an electrified container for animal deterrence. Embodiments of the present invention prevent access to the contents inside and/or provide negative feedback (training) so the animal is less likely to make further attempts for entry.

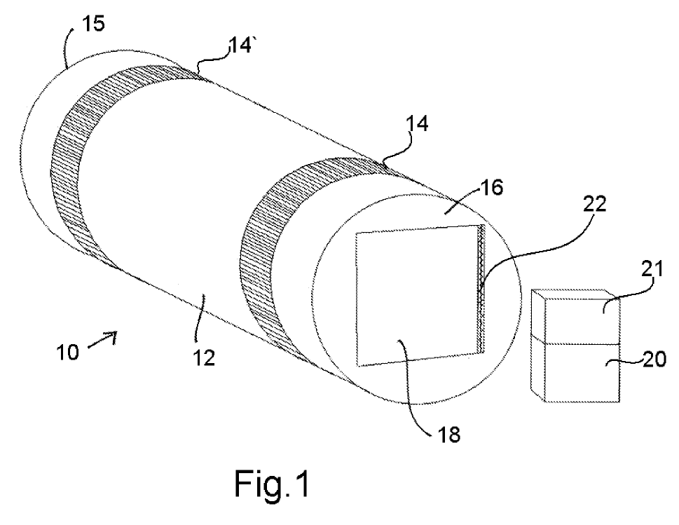

The preferred embodiment of the present invention (discussed herein this application in detail) comprises an electrified container for deterring an animal from accessing the contents held therein. One version of this preferred embodiment is shown in FIG. 1. This figure showing a container 10. The container 10 configured for opening, thereby allowing a user to store food (or other) items therein. For instance, the first end 15 of the container may be openable. In that the container 10 is configured for opening, it is likewise configured for closing, whether through use of a closure, latch, zipper, hook and loop, or other selectively releasable device.

Possible structure for the container including but not limited to clam-shell style openings, mating halves, hinged openings, slide openings, friction fits, bags, sacks, panniers, packs, etc. The embodiment shown in the drawings is a rigid or hard-sided cylindrical shaped container having a side wall 12. In another embodiment the material that container 10 is sewn from is 210 denier high tenacity double wall ripstop nylon material. This material is lightweight and durable, however there are a number of materials that could be used as substitute. Again, it is possible for the side wall of the present invention to be non-rigid, for instance the container could be a fabric bag.

Attaching to and/or connecting with the side wall 12 is preferably at least one electrical conductor. In the example shown in FIG. 1, the electrical conductor comprises two spaced apart electrically conductive materials (bands) 14, 14′ that encircle the container's side wall. In another embodiment, the electrical conductor could be combined with the container itself, for instance being an integral component to the container rather than merely attaching to or connecting with the side wall(s).

In the preferred embodiment, electrically conductive material 14 and 14′ is 1.50-inches wide and is comprised of woven plastic strands and interwoven stainless steel wiring. In the 1.50-inch width of material, there are eight individual strands of stainless steel wire. These wires are responsible for transmitting the electrical pulse provided by voltage controller 20. Electrically conductive material 14 and 14′ is sewn to side wall 12 on the exterior of container 10.

The interior wiring assembly is comprised of a seven-inch length of insulated 18 AWG Type CL2 wire and four twist-on wire connectors. The wire connectors connect the electrically conductive material 14 and 14′ on the exterior of container 10 to the seven-inch length of insulated 18 AWG Type CL2 wire. The four wire connectors easily join positive and negative wiring by twisting together the wires. The interior wire assembly is secured beneath an overlapping flap with hook and loop that it is on the underside of container 10, which runs along the long axis of the shape. The interior wiring assembly is joined to a female plug that is threaded through an interior ⅜″ grommet into the interior of the access aperture 18 and electrically interfaces with voltage controller 20.

It is preferred that the container contain a liner (not shown) therein for protecting the contents of the container. An example of a liner being a cloth lining applied to the inside surfaces of the container.

As seen in FIG. 1, the container 10 having a first end 15 and a second end 16. Container 10 is cylindrical in shape but could be made into any shape or size and still be functional as previously described. Container is hollow in the inside as to facilitate the storage of items such as food, thus forming interior space 22 as seen in FIG. 4. Referring back to FIG. 1, one end of container 10 can be opened or closed, whereas the opposing end of container 10 is permanently closed. Again, there are many alternatives for accessing the hollow portion of container 10. The second end 16 (in this embodiment) having an access aperture 18 into which a voltage controller 20 can be inserted and/or attached. Access aperture 18 can be fitted with a selectively releasable device 22. Second end 16 is opposite of the first end 15 of container 10. Second end 16 does not allow access into the interior of the Container. Positioned at 12 o'clock and 6 o'clock on second end 16, are two (2) looped tabs of nylon webbing that allow a user to grab a hold of when necessary. In another embodiment, sewn to second end 16 is a pocket, which is accessed by a zipper. The pocket has a clear window (20 G vinyl) which allows a user to visually inspect the voltage controller 20 that is stored inside this pocket.

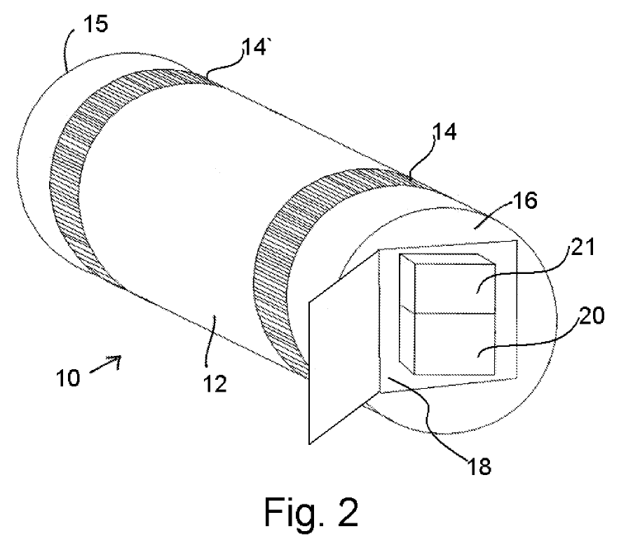

FIG. 2 showing the voltage controller 20 contained internal to container 10 by being held inside aperture 18. Other manners of attaching or integrating the voltage controller to the container are likewise envisioned, for instance voltage controller 20 could be located inside container 10 with button(s) for the operation of voltage controller 20 located on the outside surface of container 10.

The voltage controller 20 is electrically connected to at least one electrical conductor, preferably via a plurality of wires; thereby supplying an electrical charge (current) to said at least one electrical conductor. Voltage controller 20 supplies power to electrically conductive materials 14 and 14′. Secured to the positive and negative posts of voltage controller 20 is a male plug that is secured to the female clip of the interior wire assembly. When this connection is made, the voltage controller 20 is able to supply power when it is activated. In the preferred embodiment, the voltage controller 20 is powered by power source 21 comprising two AA batteries that are inserted into the back of voltage controller 20. On the front of voltage controller 20 is a button which, when depressed, can either activate or deactivate voltage controller 20. When activated voltage controller 20 provides a pulsating electrical current of 5,000 volts every 1.2 seconds. In the example shown in FIG. 1, voltage controller 20 is electrically connected to electrically conductive materials 14, 14′. In one example implementation, the voltage controller would operate much like an electric fence controller, electrifying the conductor and causing a shock when a grounded object (such as a wild animal) contacts the conductor. Other example voltage controllers include low impedance fence shockers, shockers, voltage regulators, etc.

Voltage controller 20, in the preferred embodiment, includes a control device for controlling the electrification of the conductor. For instance, control device may comprise an “on/off” switch for disengaging the electrical current to the conductor.

The voltage controller including or attaching to a power source 21. This power source including but not limited to solar cells, batteries, capacitors, alternating current, and/or direct current. In the preferred embodiment said power source 21 is comprised of at least one battery.

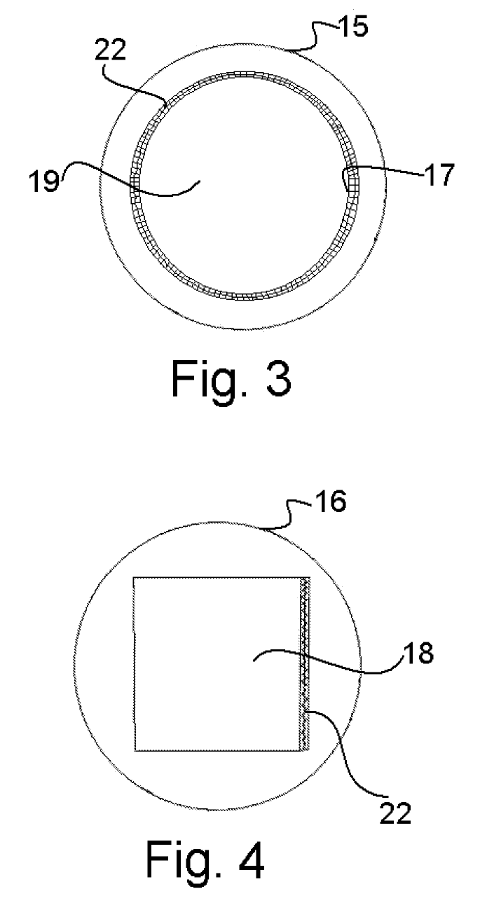

An embodiment can be seen in FIG. 3 that shows a first end 15 view of the electrified container for animal deterrence. On the first end 15 of this container embodiment is a first access aperture 17 that can be fitted with at least one selectively releasable device 22. The first access aperture is used to access the container to store items as need by the user. FIG. 4 is a second end view of the container and shows second access aperture 18, into which a voltage controller 20 can be inserted and/or attached. Second access aperture 18 can be held closed by at least one selectively releasable device 22. FIG. 3 shows container 10 being configured to form an interior space 19. Interior space 19 is configured to receive therein a user's belonging that are to be securely stored.

In use, the preferred embodiment works by applying an electrical current to one or more conductors located on the outside portion of the container, whereby if an animal (such as a bear) handles or otherwise comes into contact with the conductor(s), a shock will be delivered. Continued handling of the container will result in the delivery of additional shocks, thereby deterring the animal from continuing to attempt to open the container. After a number of such shocks, the animal will give up and look elsewhere for food. It is hoped that through such interaction with the container that the animal will be conditioned to avoid such containers in the future.

Another embodiment of the electrified container for animal deterrence presents an animal proof, lightweight, compressible, electrified storage sack that is constructed from durable fabric and other materials, and is used in conjunction with a controller that regulates and distributes an electrical charge. The controller is stowed in a pocket which is located on the non-opening end of the storage sack. The storage sack is opened and closed via a drawcord that can be tensioned by the user. The drawcord is sewn into a hem, and issues forth from that hem via a grommet. The aforementioned electrical charge is transported throughout the exterior of the storage sack by strips of woven plastic webbing that are interlaced with stainless steel wires. When the Controller is connected to the aforementioned circuitry and activated, the Storage Sack is “live” and will issue a pulsating 5,000 volt electrical shock every 1.2 seconds. This pulsing shock alters an animal's behavior by actively discouraging repeated attempts of entry into the storage sack by animals. To access the container one end of the container opens and closes through the use of a drawcord. The drawcord is comprised of 3/16″ inch shock cord/bungee cord that is sewn into a hem. The drawcord and issues forth from that hem via a ⅜″ grommet. The two ends of the bungee cord are then passed through a push button cord lock which provides tension to the drawcord to either open or close the Container.

In an embodiment a liner section is internal to container 10 to provide protection to items held within container 10. Said liner section materials could include 1.1 oz Silicon Impregnated Ripstop Nylon. This material is very lightweight, 100% waterproof, and is a bright color so as to facilitate easy viewing to the contents in the interior of container 10. The liner section is sewn as an interior bag within container 10.

The exemplary embodiments shown in the figures and described above illustrate but do not limit the invention. It should be understood that there is no intention to limit the invention to the specific form disclosed; rather, the invention is to cover all modifications, alternative constructions, and equivalents falling within the spirit and scope of the invention as defined in the claims. For example, while the exemplary embodiments illustrate the controlling of access to a container, the invention is not limited to use with containers and may be used with other animal control devices. While the invention is not limited to use with containers, it is expected that various embodiments of the invention will be particularly useful in such devices. Hence, the foregoing description should not be construed to limit the scope of the invention, which is defined in the following claims.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. An electrified container for animal deterrence, comprising:
a storage container configured so as to form an interior space, said container having at least one access aperture;
at least one section of electrically conductive material fixedly attached to the exterior of said storage container, wherein said section of electrically conductive material is configured to conduct current through a grounded object when said grounded object comes into contact with said at least one section of electrically conductive material;
at least one voltage controller electrically attached to said at least one section of electrically conductive material, wherein said voltage controller is configured to control the electrification of said at least one section of said electrically conductive material;
at least one power source electrically interfaced with said at least one voltage controller, wherein said at least one power source is configured to provide electrical energy to said at least one voltage controller; and
whereby said electrified container for animal deterrence is configured to provide an electric shock to said grounded object that comes into contact to said at least one section of electrically conductive material, and wherein said grounded object is an animal.

2. The electrified container for animal deterrence of claim 1, wherein said at least one voltage controller is housed internal to said storage container.

3. The electrified container for animal deterrence of claim 2, wherein said at least one voltage controller is accessed via said at least one access aperture.

4. The electrified container for animal deterrence of claim 1, wherein said at least one voltage controller is attached external to said storage container.

5. The electrified container for animal deterrence of claim 1, wherein said at least one power source is comprised of an alternating current power source.

6. The electrified container for animal deterrence of claim 1, wherein said at least one power source is comprised of a direct current power source.

7. The electrified container for animal deterrence of claim 1, wherein said storage container is comprised of rigid material.

8. The electrified container for animal deterrence of claim 1, wherein said storage container is comprised of fabric material.

9. The electrified container for animal deterrence of claim 1, wherein said at least one voltage controller is housed internal to said storage container, accessed via said at least one access aperture, and wherein said at least one power source is comprised of a direct current power source.

10. An electrified container for animal deterrence, comprising:
a storage container configured so as to form an interior space, said container having a first and a second access aperture which are each fitted with at least one selectively releasable device;
at least one section of electrically conductive material fixedly attached to the exterior of said storage container, wherein said section of electrically conductive material is configured to conduct current through a grounded object when said grounded object comes into contact with said at least one section of said electrically conductive material;
at least one voltage controller electrically attached to said at least one section of electrically conductive material, wherein said voltage controller is configured to control the electrification of said at least one section of electrically conductive material;
at least one power source electrically interfaced with said at least one voltage controller, wherein said at least one power source is configured to provide electrical energy to said at least one voltage controller; and
whereby said electrified container for animal deterrence is configured to provide and electric shock to a grounded object that comes into contact to said at least one section of electrically conductive material, and wherein said grounded object is an animal.

11. The electrified container for animal deterrence of claim 10, wherein said at least one voltage controller is housed internal to said storage container and accessed through said second access aperture.

12. The electrified container for animal deterrence of claim 10, wherein said at least one power source is comprised of an alternating current power source.

13. The electrified container for animal deterrence of claim 10 wherein said at least one power source is comprised of a direct current power source.

14. The electrified container for animal deterrence of claim 10, wherein said storage container is comprised of rigid material.

15. The electrified container for animal deterrence of claim 10, wherein said storage container is comprised of fabric material.

16. An electrified container for animal deterrence, comprising:
a storage container configured so as to form an interior space, said container having a first and a second access aperture which are each fitted with at least one selectively releasable device;
at least one section of electrically conductive material fixedly attached to the exterior of said storage container, wherein said section of electrically conductive material is configured to conduct current through a grounded object when said grounded object comes into contact with said at least one section of said electrically conductive material;
at least one voltage controller electrically attached to said at least one section of electrically conductive material, wherein said voltage controller is configured to control the electrification of said at least one section of electrically conductive material, and said at least one voltage controller is housed internal to said storage container and accessed through said second access aperture;
at least one power source electrically interfaced with said at least one voltage controller, wherein said at least one power source is configured to provide electrical energy to said at least one voltage controller and said power source is comprised of at least one battery; and
whereby said electrified container for animal deterrence is configured to provide and electric shock to a grounded object that comes into contact to said at least one section of electrically conductive material, and wherein said grounded object is an animal.
